(19) United States
(12) Patent Application Publication
(10) Pub. No.: US 2002/0190699 A1
(43) Pub. Date: Dec. 19, 2002

(54) Controllable damping member, method of controlling, and system using the damping member

(76) Inventors: Roland Mueller-Fiedler, Leonberg (DE); Thomas Walter, Renningen (DE); Markus Ulm, Stuttgart (DE); Johannes Schier, Beilstein (DE); Erich Kasper, Pfaffenhofen (DE)

Correspondence Address: STRIKER, STRIKER & STENBY, 103 East Neck Road, Huntington, NY, 11743, US

(21) Appl. No.: 10/096,889

(22) Filed: Mar. 13, 2002

(30) Foreign Application Priority Data
Mar. 22, 2001 (DE) 1 01 14 037.1

(51) Int. Cl. G05F 3/16; G05F 1/56; G05F 1/618

(52) U.S. Cl. 323/224; 323/282; 323/304

(57) ABSTRACT

A controllable damping member has a substrate with a semiconductor material; a coplanar conductor applied on the substrate and having a metalization; and a control voltage applied between the metalization of the coplanar conductor and the semiconductor material of the substrate and determining a damping of the coplanar conductor.

### BACKGROUND OF THE PRESENT INVENTION

The present invention relates to controllable damping members, methods of controlling clamping members, and systems using the same.

Controllable damping members are important components in micro and millimeter wave circuits for power adaptation of levels. An important application is the regulation of the transmission power of an antenna. Such controllable damping members can be realized in a high frequency circuit with pin-diodes or MESFETs, whose “on”-resistance is modulated via a voltage.

### SUMMARY OF THE INVENTION

Accordingly, it is an object of present invention to provide a controllable damping member which has a very simple construction and can be integrated simply in millimeter wave circuits.

In keeping with these objects and with others which will become apparent herein after, one feature of present invention resides, briefly stated in a controllable damping member comprising a substrate with a semiconductor material; a coplanar conductor applied on said substrate and having a metallization; and a control voltage applied between said metallization of said coplanar conductor and the semiconductor material of said substrate and determining a damping of said coplanar conductor.

In contrast to controllable damping members of the prior art, the inventive controllable damping member has numerous advantages. The production of pin-diodes and MESFETs requires complex process steps. The integration of such components in millimeter wave circuits is connected with technological difficulties and costs. This is especially true for antenna arrays in which in some cases individual gaps must be damped separately and therefore several active components are needed. In addition active components have relatively high insertion damping when compared with the invention.

The present invention is based on the following considerations. The damping of coplanar conductors on semiconductor substrates in particular silicon, depends on the density of movable charge carriers primarily on the semiconductor surface, or in other words low damping conductors require high ohmig substrates. By modulation of the concentration of movable charge carrier on the semiconductor circuit, the conductor damping can be adjusted. This can be performed by an electrical voltage between conductor and substrate known as a metal-insulator-semiconductor effect as disclosed in S.M.Sze: Physics of Semiconductor Devices, Second Edition, John Wiley and Sons, 1981, pages 262-379. Thereby this effect can be used for controllable damping members. The inventive structures are characterized by very simple construction and in particular a simple integrating ability in millimeter wave circuits.

It is in particular possible to control microwave or millimeter wave power radiated by an antenna and supplied through a conductor by variation of the conductor damping. A power regulation of the millimeter wave source or a further active component, pin-diode or MESSFET, is dispensed with. When an antenna is used both in a transmitting as well as a receiving branch, then the small insertion damping makes possible to integrate the damping member in the joint supply conductor. Since the costs for the individual damping member are relatively low, an application of antenna array is advantageous in which individual gaps and/or columns must be damped separately.

It is particularly advantageous when the present invention is used for the power regulation in the systems of automotive cruise control or short range radar. Permission problems because of too much irradiated power can be avoided with the inventive solutions.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a controllable damping member with a control voltage between a metalization of a coplanar conductor and a rear side metalization of a substrate;

FIG. 2 is a view showing a controllable damping member with a control voltage between a signal conductor and a ground coating of the coplanar conductor;

FIG. 3 is a view showing a controllable damping member with a control voltage between a metalization of a coplanar conductor and a contact to an n-doped trough in a p-doped semiconductor material;

FIG. 4 is a view showing an application of the controllable damping member in a supply conductor of an antenna.

### DESCRIPTION OF THE PREFERRED EMBODIMENTS

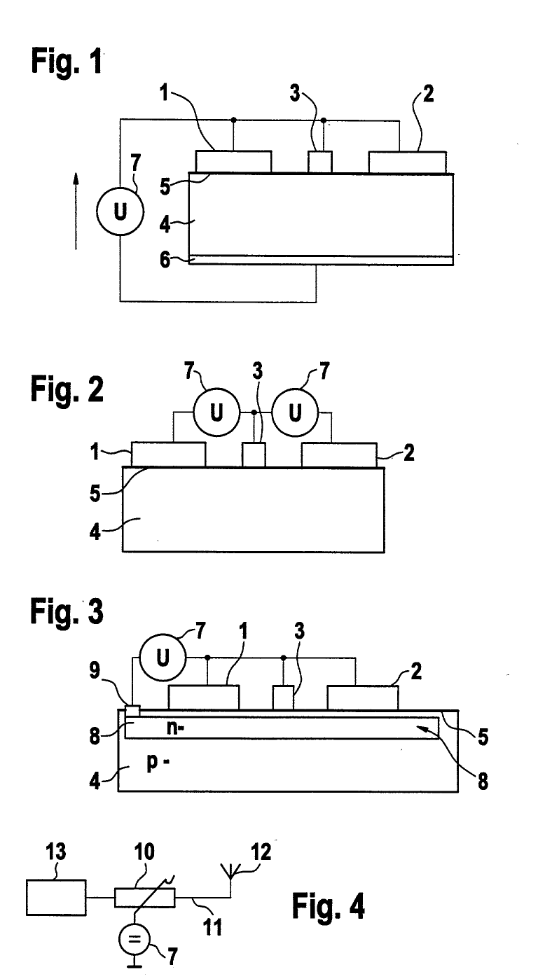

FIGS. 1, 2 and 3 show a coplanar conductor which is composed of two outer ground coatings 1 and 2 and a signal conductor 3 therebetween of a high ohmig semiconductor material (semiconductor substrate) 4, for example SiO₂ or Si₃N₄. Subsequently the outer ground coatings 1 and 2 and the signal conductor are identified together as a metalization of the coplanar conductor.

A thin insulating layer 5 is provided between the metalization 1, 2, 3 and the semiconductor substrate 4. The lower side of the semiconductor substrate 4 in FIG. 1 is provided with a rear side metallization 6. The rear side metallization 6 is composed for example of aluminum.

By applying a voltage between the metalization 1, 2, 3, of the coplanar conductor through corresponding conductors the damping of the coplanar conductor is influenced and thereby a controllable damping member is realized. By the applied voltage, on the semiconductor surface in accordance with the well known physics of a metal-insulator-semiconductor structure disclosed in the above mentioned publication, movable charge carriers are generated or modulated. Thereby the damping of the electromagnet wave of the coplanar conductor is influenced by such a control voltage.

In the embodiments shown in FIG. 1 this control voltage 7 is provided between the metalization 1, 2, 3 and the rear side metalization 6. In the embodiment of FIG. 2 the control voltages 7 are each provided between an outer ground coating 1 or 2 and the signal conductor 3. In the embodiment of FIG. 3 in a p-doped substrate 4, an n-doped trough 8 is provided. The control voltage 7 is located here between the metalization 1, 2, 3, and a contact 9 to the n-doped trough. Naturally the doping can be reversed, such as for example a p-doped trough 8 in an n-doped substrate 4.

Also, several signal conductors can be arranged between the ground coatings in correspondence with the technical paper “Open-End Length Extension in Coplanar Waveguide Coupled Line DC Blocks with finite Ground Planes of S. Uysal (http://ww.eng.nus.etu.sg./EResnews/9808/p11.html). For controllable damping at least one of these control conduits is connected to the control voltage 7.

At which control voltage the minimumal of the damping is provided, depends on the selection of the metalization of the semiconductor material and the insulating layer. For example, with solid charges (elektred) available in the insulating layer, the threshold voltage can be displaced considerably, for example by 30 V. Thereby also structures are realized, which exhibit at 0 V strong damping, and exhibit at 30 V their damping minimum.

The controllable damping member 10 of the invention is suitable advantageously for the use in the supply conduit (power supply) 11 of an antenna 12 as shown in FIG. 4, as well as for transmitting and receiving operation, and is operatable by a high frequency circuit 13. In particular when the supply conductor 11 is formed as a coplanar conductor, eventually as a component of the high frequency circuit 13, no additional controllable, in particular active damping members are needed for limiting the power irradiated from the antenna 12. The thusly available coplanar conductor must be however loaded with the control voltage 7.

A further advantageous application of the inventive damping member is in an antenna array in which the individual columns and/or lines should be damped separately. In the power supply of each column and/or line to be separately dampened the inventive damping member is provided.

The inventive is suitably advantageously for power regulation in automatic cruise control or short range radar systems to limit the power radiated by the antennas.

It will be understood that each of the elements described above, or two or more together, may also find a useful application in other types of constructions differing from the types described above.

While the invention has been illustrated and described as embodied in controllable damping member, method of controlling, and system used the damping member, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A controllable damping member, comprising a substrate with a semiconductor material; a coplanar conductor applied on said substrate and having a metallization; and a control voltage applied between said metallization of said coplanar conductor and the semiconductor material of said substrate and determining a damping of said coplanar conductor.

2. A controllable damping member as defined in claim 1; and further comprising a rear side metalization provided on said semiconductor material, said control voltage between provided between said metalization of said coplanar conductor and said rear side metalization of said semiconductor material.

3. A controllable damping member as defined in claim 1, wherein said coplanar conductor is provided with a ground coating, said control voltage is provided between a signal conductor and said ground coating of said coplanar conductor.

4. A controllable damping member as defined in claim 1; and further comprising a contact to an n-doped trough in said semiconductor material of said substrate which is p-doped, said control voltage being provided between said metalization of said coplanar conductor and said contact to said n-doped trough.

5. A controllable damping member as defined in claim 1; and further comprising a contact to a p-doped trough in said semiconductor material of said substrate which is n-doped, said control voltage being provided between said metalization of said coplanar conductor and said contact to said p-doped trough.

6. A controllable damping member as defined in claim 1; and further comprising an insulating layer provided between said metalization of said coplanar conductor and said semiconductor material of said substrate.

7. A controllable damping member as defined in claim 6, wherein said control voltage is applied to determine said damping such that at least one of a damping minimum and a damping maximum is provided in dependence on fixed charges available in said insulating layer.

8. A device, comprising an antenna for a transmitting and a receiving region; and a damping member arranged in a power supply of said antenna and comprising a substrate with a semiconductor material; a coplanar conductor applied on said substrate and having a metalization; and a control voltage applied between said metalization of said coplanar conductor and said semiconductor material of said substrate and determining a damping of said coplanar conductor.

9. An antenna array system, comprising an antenna array; and means for different damping of columns and/or lines of the array, said means including damping member having a substrate with a semiconductor material; a coplanar conductor applied on said substrate and having a metalization; and a control voltage applied between said metalization of said coplanar conductor and said semiconductor material of said substrate and determining a damping of said coplanar conductor.

10. A method of controlling damping of a coplanar conductor applied on a substrate with a semiconductor material, comprising the steps of modulating a concentration of movable charge carriers on a semiconductor surface by a control voltage between a metalization of a coplanar conductor and the substrate.

11. An automotive cruise control comprising a damping member provided for power regulation and including a substrate with a semiconductor material; a coplanar conductor applied on said substrate and having a metalization; and a control voltage applied between said utilization of said coplanar conductor and said semiconductor material of said substrate and determining a damping of said coplanar conductor.

12. An automotive cruise control including a device for power regulation and comprising an antenna for transmitting and receiving region; and a damping member arranged in the power supply of said antenna and comprising a substrate with a semiconductor material, a coplanar conductor applied on said substrate and having a metalization; and a control voltage applied between said metalization of said coplanar conductor and said semiconductor material of said substrate and determining a damping of said coplanar conductor.

13. An automatic cruise control, operating with a method comprising the steps of controlling damping of a coplanar conductor applied on a substrate with a semiconductor material, and modulating a concentration of movable charge carriers on a semiconductor surface by a control voltage between a metalization of the coplanar conductor and the substrate.

14. A short range radar including comprising a damping member provided for power regulation and including a substrate with a semiconductor material; a coplanar conductor applied on said substrate and having a metalization; and a control voltage applied between said metalization of said coplanar conductor and said semiconductor material of said substrate and determining a damping of said coplanar conductor.

15. A short range radar including a device for power regulation and comprising an antenna for transmitting and receiving region; and a damping member arranged in the power supply of said antenna and comprising a substrate with a semiconductor material, a coplanar conductor applied on said substrate and having a metalization; and a control voltage applied between said metalization of said coplanar conductor and a semiconductor material of said substrate and determining a damping of said coplanar conductor.

16. A short range radar, operating with a method comprising the steps of controlling damping of a coplanar conductor applied on a substrate with a semiconductor material, and modulating a concentration of movable charge carriers on a semiconductor surface by a control voltage between a metalization of the coplanar conductor and the substrate.
